(19) United States
(12) Patent Application Publication
(10) Pub. No.: US 2012/0265953 A1
(43) Pub. Date: Oct. 18, 2012

(54) MEMORY MANAGEMENT DEVICE, MEMORY MANAGEMENT METHOD, AND CONTROL PROGRAM

(76) Inventors: Yasuhiro MATSUZAKI, Tokyo (JP); Kazumi SATO, Kanagawa (JP)

(21) Appl. No.: 13/435,959

(22) Filed: Mar. 30, 2012

(30) Foreign Application Priority Data
Apr. 12, 2011 (JP) 2011-087945

(51) Int. Cl. G06F 12/00

(52) U.S. Cl. 711/155; 711/154; 711/E12.001

(57) ABSTRACT

When a page on a random access memory (RAM) having a value matching a page on a read only memory (ROM) is detected, a memory management section of a memory manager updates a conversion table so that the page on the ROM having the matching value is referred to, and discards the detected page on the RAM. The present technology is applicable to, for example, a built-in device.

### BACKGROUND

The present technology relates to a memory management device, a memory management method, and a control program, and more particularly, to a memory management device, a memory management method, and a control program capable of reducing a use amount of a main storage device.

In the related art, data read in place (DRIP) is well-known as technology for implementing memory reduction in a system including a read only memory (ROM) randomly accessible from a central processing unit (CPU) such as a random access memory (RAM), that is, a ROM from which data is readable directly from the CPU in units of addresses. In a system to which DRIP is applied, the CPU reads an initial value of data directly from the ROM without copying the initial value of the data to the RAM, and first copies the data to the RAM when writing the data.

In addition, technology for generating difference data from original data in a read-only file system, compressing the difference data, and storing the compressed data in a swap area within a main storage device when data within the main storage device is swapped out has been proposed in the related art (for example, see Japanese Patent Application Laid-Open No. 2008-140236).

### SUMMARY

However, although there is the effect of memory reduction until data is written in the system to which DRIP is applied, there is no effect of memory reduction for data written once because the data remains in the RAM until an area of the data is released.

In addition, although there is the effect of memory reduction for data to be swapped out in the technology disclosed in Japanese Patent Application Laid-Open No. 2008-140236, there is no effect of memory reduction for data to be used without being swapped out.

It is desirable to reduce a use amount of a main storage device.

According to an embodiment of the present disclosure, there is provided a memory management device including a memory management section for discarding data of a main storage device matching data of an auxiliary storage device during execution of a predetermined program and controlling the discarded data to be read from the auxiliary storage device.

The data of the auxiliary storage device may include initial data indicating an initial value before the program is executed, and prediction data predicted to occur in the main storage device during the execution of the program.

The prediction data may be data predicted on the basis of content of the main storage device when the program is executed.

The prediction data may be data extracted on the basis of at least one of an occurrence frequency and period from data occurring in the main storage device when the program is executed.

The prediction data may be stored in the auxiliary storage device in units of blocks having a predetermined size, and the memory management section may secure an area of the main storage device in the units of blocks according to a request from the program.

The prediction data may be stored in the auxiliary storage device in a compressed state.

The memory management device may further include a prediction-data generation section for generating the prediction data on the basis of the content of the main storage device during the execution of the program and storing the generated prediction data in the auxiliary storage device.

When data of the auxiliary storage device is rewritten, the memory management section may copy the corresponding data to the main storage device and control the data copied to the main storage device to be rewritten.

According to another embodiment of the present disclosure, there provided is a memory management method including discarding data of a main storage device matching data of an auxiliary storage device during execution of a predetermined program, and controlling the discarded data to be read from the auxiliary storage device.

According to another embodiment of the present disclosure, there provided is a control program including discarding data of a main storage device matching data of an auxiliary storage device during execution of a predetermined program, and controlling the discarded data to be read from the auxiliary storage device.

According to another embodiment of the present disclosure, there provided is a control program for causing a computer to execute a process including discarding data of a main storage device matching data of an auxiliary storage device during execution of a predetermined program, and controlling the discarded data to be read from the auxiliary storage device.

According to the embodiments of the present technology described above, a use amount of a main storage device can be reduced.

### BRIEF DESCRIPTION OF THE DRAWINGS

FIG. 1 is a block diagram illustrating an embodiment of an information processing system to which the present technology is applied;

FIG. 2 is a block diagram illustrating a configuration example of a function of a memory manager;

FIG. 3 is a diagram illustrating an example of data stored in a ROM;

FIG. 4 is a flowchart illustrating a data read process;

FIG. 5 is a flowchart illustrating a data write process;

FIG. 6 is a diagram illustrating specific examples of the data read process and the data write process;

FIG. 7 is a diagram illustrating specific examples of the data read process and the data write process;

FIG. 8 is a diagram illustrating specific examples of the data read process and the data write process;

FIG. 9 is a flowchart illustrating a memory rearrangement process;

FIG. 10 is a diagram illustrating a specific example of the memory rearrangement process;

FIG. 11 is a diagram illustrating a specific example of the memory rearrangement process;

FIG. 12 is a diagram illustrating a modified example of a method of storing a prediction page;

FIG. 13 is a diagram illustrating an example of a method of securing a memory area;

FIG. 14 is a block diagram illustrating a second configuration example of a function of a memory manager; and

FIG. 15 is a flowchart illustrating a prediction-page generation process.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the embodiments of the present technology will be described. Description will be given in the following order.

1. Embodiments

2. Modified Examples

### 1. EMBODIMENTS

[Configuration Example of Information Processing System]

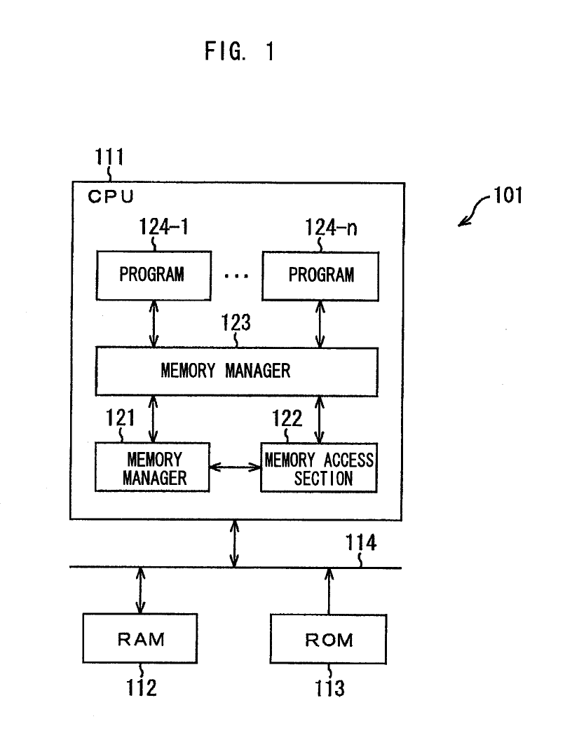

FIG. 1 is a block diagram illustrating an embodiment of an information processing system 101 to which the present technology is applied.

The information processing system 101 is, for example, a system applicable to various built-in devices of a television receiver, a mobile phone, and the like, or a computer.

The information processing system 101 includes a CPU 111, a RAM 112, and a ROM 113. The CPU 111, the RAM 112, and the ROM 113 are mutually connected via a bus 114.

The CPU 111 implements various functions by executing various programs.

The RAM 112 provided as a main storage device temporarily stores a program and data necessary for a process of the CPU 111.

The ROM 113 provided as an auxiliary storage device stores a program and data necessary for a process of the CPU 111. In addition, the data stored in the ROM 113 includes initial data and prediction data.

Here, the initial data indicates initial values of various data before an operation of the information processing system 101 is initiated. In other words, the initial data indicates initial values of various data before programs 124-1 to 124-n to be described later are executed.

In addition, the prediction data of which details will be described later is data predicted to occur on the RAM 112 during the operation of the information processing system 101, that is, during execution of the programs 124-1 to 124-n.

In addition, the ROM 113 is constituted by a randomly accessible ROM, that is, a ROM from which data is readable directly from the CPU 111 in units of addresses.

Here, a configuration example of software of the information processing system 101 will be described.

In the information processing system 101, for example, virtual storage of a paging scheme is implemented by an operating system (OS) to be executed by the CPU 111. That is, an address space of the ROM 113 is divided into pages, which are blocks having a predetermined size, and data on the ROM is arranged in the RAM 112 in units of pages when necessary.

The memory manager 121 and the memory access section 122 are provided, for example, as a part of functions of the OS.

The memory manager 121 arranges a program and data on the ROM 113 in the RAM 112, and controls an area of the RAM 112 to be secured and released. In addition, the memory manager 121 notifies the memory manager 123 of a processing result for a request from the memory manager 123.

Further, the memory manager 121 generates and updates a conversion table by which a virtual address is converted into a physical address so as to access the RAM 112 and the ROM 113, and causes the RAM 112 to store the conversion table. In addition, the memory manager 121 notifies the memory access section 122 of the fact that the conversion table has been updated. The conversion table is constituted, for example, by an address conversion table, a page table, or a memory map.

Further, the memory manager 121 acquires a profile of content of the RAM 112 during the execution of the programs 124-1 to 124-n (analyzes the content of the RAM 112), and outputs its result to the outside.

According to a request from the memory manager 123, the memory access section 122 reads data from the RAM 112 or the ROM 113 in units of addresses using the conversion table, and passes the read data to the memory manager 123. In addition, according to a request from the memory manager 123, the memory access section 122 writes data to the RAM 112 in units of addresses using the conversion table. Further, if a page including data of an object to be written is not on the RAM 112, the memory access section 122 notifies the memory manager 121 of the fact that the page is not on the RAM 112.

The memory manager 123 provides a library function for reading data of the RAM 112 and the ROM 113 or writing data to the RAM 112, for example, to the programs 124-1 to 124-n. The memory manager 123 converts a data read or write request from the programs 124-1 to 124-n into a format executable by the memory access section 122, and notifies the memory access section 122 of the request.

In addition, the memory manager 123 provides, for example, a library function for securing or releasing an area of the RAM 112. The memory manager 123 converts an area securement or release request from the programs 124-1 to 124-n into a format executable by the memory manager 121, and notifies the memory manager 121 of the request.

The programs 124-1 to 124-n include an application program for enabling the CPU 111 to implement a predetermined function, and the like.

Hereinafter, if the programs 124-1 to 124-n do not need to be individually distinguished, these are simply referred to as a program 124.

[Configuration Example of Function of Memory Manager 121]

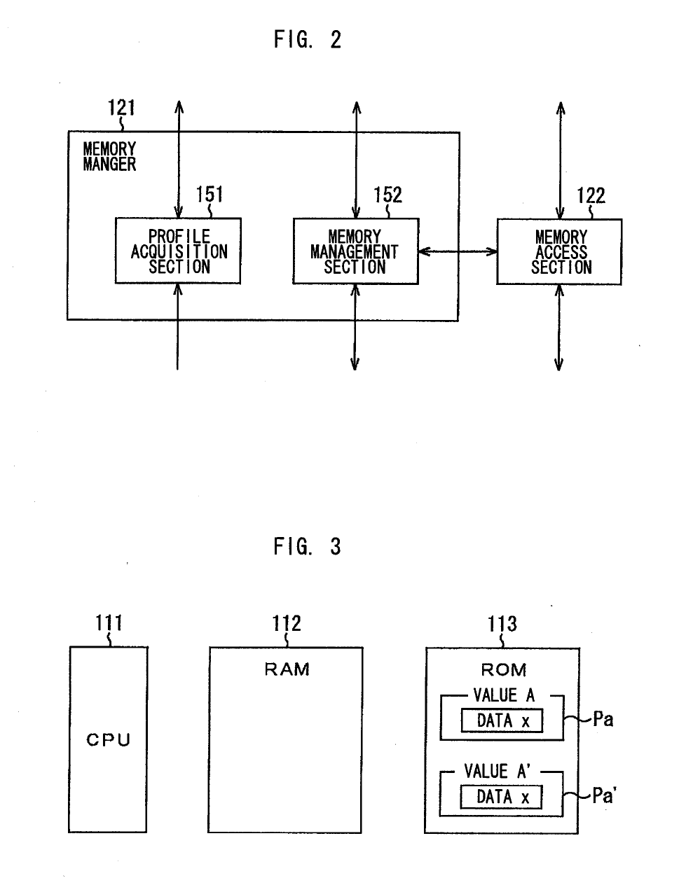

Next, the configuration example of the function of the memory manager 121 will be described with reference to FIG. 2.

The memory manager 121 is configured to include a profile acquisition section 151 and a memory management section 152.

The profile acquisition section 151 acquires a profile of content of the RAM 112 during execution of the program 124 (analyzes the content of the RAM 112), and outputs its result to an outside.

The memory management section 152 arranges a program and data on the ROM 113 in the RAM 112, and controls an area of the RAM 112 to be secured and released. In addition, the memory management section 152 notifies the memory manager 123 of a processing result for a request from the memory manager 123. Further, the memory management section 152 generates and updates a conversion table and causes the RAM 112 to store the conversion table. In addition, the memory management section 152 notifies the memory access section 122 of the fact that the conversion table is updated.

[Prediction Method for Prediction Data]

Here, a prediction method for prediction data stored in the ROM 113 will be described. The prediction data is predicted, for example, in a development stage of the information processing system 101, and the information processing system 101 is shipped in a state in which the prediction data is stored in the ROM 113.

First, the profile acquisition section 151 acquires a profile of content of the RAM 112 when the program 124 is normally executed, and outputs the acquired profile outside the information processing system 101. The profile output to the outside is recorded on a recording device (not illustrated).

At this time, profiles may be continuously acquired or discretely acquired every predetermined interval or when a predetermined condition is satisfied. In addition, the profile acquisition section 151 may directly output the content of the RAM 112, particularly, without processing or analysis, or the content may be output after processing or analysis is applied so that it is easily processed in a subsequent process.

On the basis of the recorded profile, a page on the RAM 112 having a value different from that of a page stored in the ROM 113 is extracted. In other words, a page occurring only in the RAM 112 is extracted during execution of the program 124. This page is, for example, a page to which a value is rewritten after a copy from the ROM 113 to the RAM 112, or a page to which a value is written after it is secured by the CPU 111 in the RAM 112.

All or some of extracted pages are stored in the ROM 113 as prediction data. An amount of prediction data stored in the ROM 113 is determined by a capacity of the ROM 113. For example, if a space remains in the capacity of the ROM 113, all prediction data can be stored in the ROM 113. On the other hand, if no space remains in the capacity of the ROM 113, it is necessary to extract part of the prediction data and store the part of the prediction data in the ROM 113.

In the latter case, for example, it is possible to extract the prediction data on the basis of at least one of an occurrence frequency and period in the RAM 112 during the execution of the program 124. That is, prediction data of which an occurrence frequency is high or prediction data of which a period is long is preferentially extracted. In addition, for example, among pages occurring in the RAM 112, a page having a large difference as compared to an initial value may be preferentially stored in the ROM 113 as the prediction data.

In addition, if data is known in advance to occur in the RAM 112 during the execution of the program 124 according to characteristics of the program 124, it is preferable that the data be stored in the ROM 113 as the prediction data.

Hereinafter, a page including initial data is referred to as an initial page and a page including prediction data is referred to as a prediction page.

[Process of Information Processing System 101]

Next, a process to be executed by the information processing system 101 will be described with reference to FIGS. 2 to 11.

Hereinafter, as illustrated in FIG. 3, an initial page Pa and a prediction page Pa′ are assumed to be stored in the ROM 113. In addition, the prediction page Pa′ is assumed to correspond to a page occurring in the RAM 112 when a value A of the entire initial page Pa is rewritten to a value A′ during execution of the program 124. Further, hereinafter, data x is assumed to be included in both the initial page Pa and the prediction page Pa′. The data x is unit data to be actually processed by the program 124.

[Data Read Process]

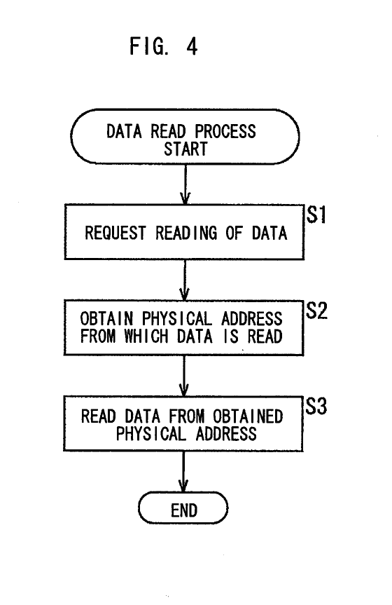

First, the data read process to be executed by the information processing system 101 will be described with reference to the flowchart of FIG. 4.

In step S1, the program 124 requests the memory manager 123 to read data.

In step S2, the memory access section 122 obtains a physical address from which the data is read. Specifically, the memory manager 123 obtains a virtual address of the data of which reading is requested by the program 124, and requests the memory access section 122 to read the data from the obtained virtual address. The memory access section 122 converts the virtual address designated by the memory manager 123 into a physical address on the basis of a conversion table.

In step S3, the memory access section 122 reads the data from the obtained physical address. That is, the memory access section 122 reads the data from the ROM 113 if the obtained physical address is an address on the ROM 113, and reads the data from the RAM 112 if the obtained physical address is an address on the RAM 112. The memory access section 122 passes the read data to the program 124 of a request source via the memory manager 123.

Thereafter, the data read process ends.

[Data Write Process]

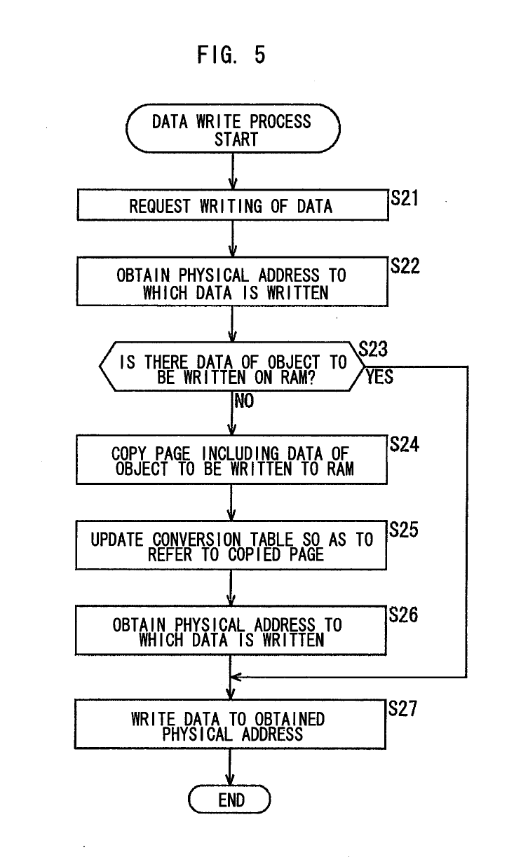

Next, the data write process to be executed by the information processing system 101 will be described with reference to the flowchart of FIG. 5.

In step S21, the program 124 requests the memory manager 123 to write data.

In step S22, the memory access section 122 obtains a physical address to which the data is written. Specifically, the memory manager 123 obtains a virtual address of the data of which writing is requested by the program 124, and requests the memory access section 122 to write the data to the obtained virtual address. On the basis of a conversion table, the memory access section 122 converts the virtual address designated by the memory manager 123 into a physical address.

In step S23, the memory access section 122 determines whether or not data of an object to be written is on the RAM 112 on the basis of the obtained physical address. If the data of the object to be written is determined not to be on the RAM 112, the process proceeds to step S24.

In step S24, the memory management section 152 copies a page including the data of the object to be written to the RAM 112. Specifically, the memory access section 122 notifies the memory management section 152 of the fact that the page including the data of the object to be written is not on the RAM 112. The memory management section 152 copies the page on the ROM 113 reported from the memory access section 122 to the RAM 112.

In step S25, the memory management section 152 updates the conversion table so that the copied page is referred to. That is, the memory management section 152 updates the conversion table by changing a conversion destination of a virtual address associated with a physical address of a page (an initial page or a prediction page) on the ROM 113 of a copy source to the physical address of the copied page on the RAM 112. Thereby, thereafter, the memory access section 122 accesses the page on the RAM 112 of a copy destination in place of the page on the ROM 113 of the copy source. The memory management section 152 notifies the memory access section 122 of the fact that the conversion table is updated.

In step S26, the memory access section 122 performs the same process as in step S22 on the basis of the updated conversion table, and obtains the physical address to which the data is written.

Thereafter, the process proceeds to step S27.

On the other hand, if the data of the object to be written is determined to be on the RAM 112 in step S23, the processes of steps S24 to S26 are skipped and the process proceeds to step S27.

In step S27, the memory access section 122 writes the data to the obtained physical address. The memory access section 122 notifies the program 124 of the request source of data write completion via the memory manager 123.

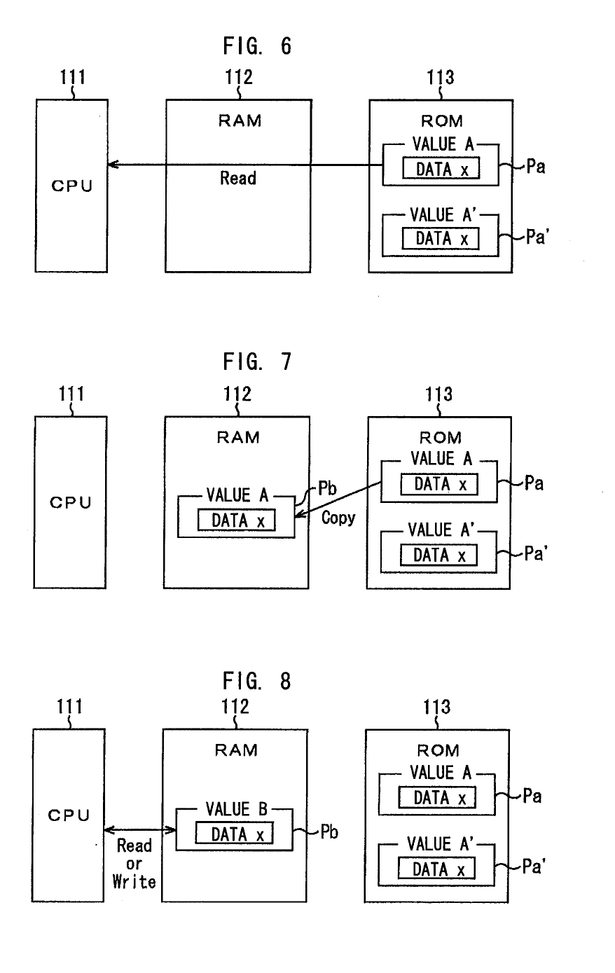

Here, specific examples of the data read process of FIG. 4 and the data write process of FIG. 5 will be described with reference to FIGS. 6 to 8.

Before a value of data within the initial page Pa is rewritten, the CPU 111 directly reads from the initial page Pa on the ROM 113 as illustrated in FIG. 6, for example, when data x is read.

On the other hand, when the value of data within the initial page Pa is rewritten, the CPU 111 copies the initial page Pa on the ROM 113 to the RAM 112 as illustrated in FIG. 7. As illustrated in FIG. 8, the CPU 111 rewrites a value of data within a page Pb copied to the RAM 112. As a result, a value of the entire page Pb becomes a value B different from a value A of the entire initial page Pa.

Thereafter, the CPU 111 reads from the page Pb on the RAM 112 as illustrated in FIG. 8, for example, when data x is read. Likewise, the CPU 111 writes the data x within the page Pb on the RAM, for example, when a value of the data x is changed.

As described above, if data of an object to be written is not on the RAM 112, a page including the data of the object to be written is copied from the ROM 113 to the RAM 112. The data is written within the page copied to the RAM 112. Thereafter, the data within the page copied to the RAM 112 is read and written.

[Memory Rearrangement Process]

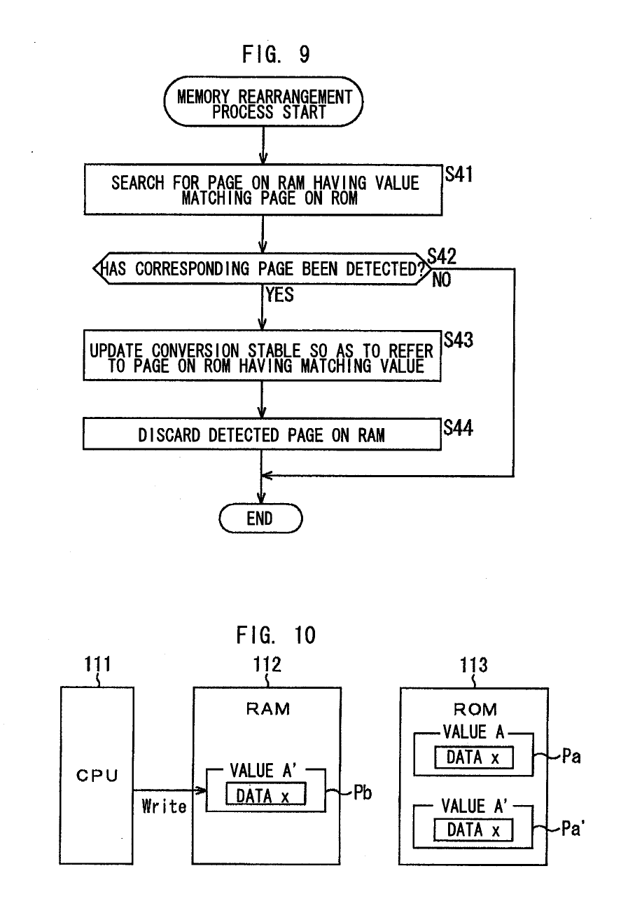

Next, the memory rearrangement process to be executed by the information processing system 101 will be described with reference to the flowchart of FIG. 9.

This process is executed when an empty capacity of the RAM 112 is insufficient, such as when an area of the RAM 112 is not ensured or when the empty capacity of the RAM 112 is less than or equal to a predetermined threshold, for example, according to a request from the program 124. Alternatively, this process is executed, for example, when there is a margin in the processing capability of the CPU 111, or at arbitrary timing.

In addition, hereinafter, as illustrated in FIG. 10, the CPU 111 writes to the page Pb on the RAM 112, so that a value of the entire page Pb matches a value A′ of the entire prediction page Pa′.

In step S41, the memory management section 152 searches for a page on the RAM 112 having a value matching a page on the ROM 113.

An arbitrary method can be adopted as a search method to be used here. For example, it is possible to add hash values indicating page values to an initial page and a prediction page on the ROM 113 and perform a search using the hash values.

In step S42, the memory management section 152 determines whether or not a corresponding page has been detected as a result of the process of step S41. If the corresponding page, that is, the page on the RAM 112 having the value matching the page on the ROM 113, is determined to have been detected, the process proceeds to step S43.

In step S43, the memory management section 152 updates a conversion table so that the matching page on the ROM 113 is referred to. That is, the memory management section 152 updates the conversion table by changing a conversion destination of a virtual address associated with a physical address of a corresponding page on the RAM to a physical address of a page on the ROM 113 having a matching value with respect to all detected pages on the RAM 112.

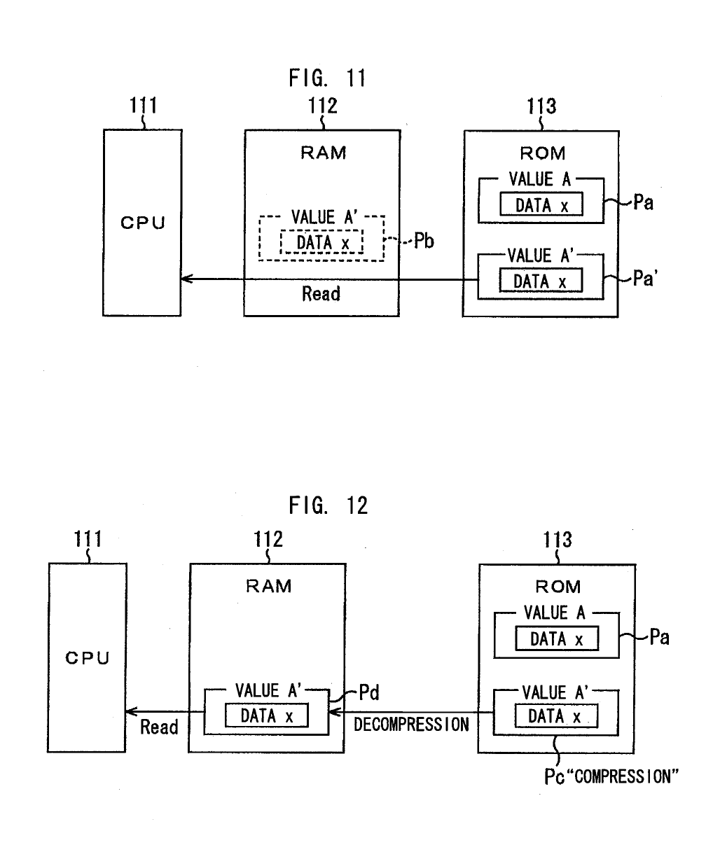

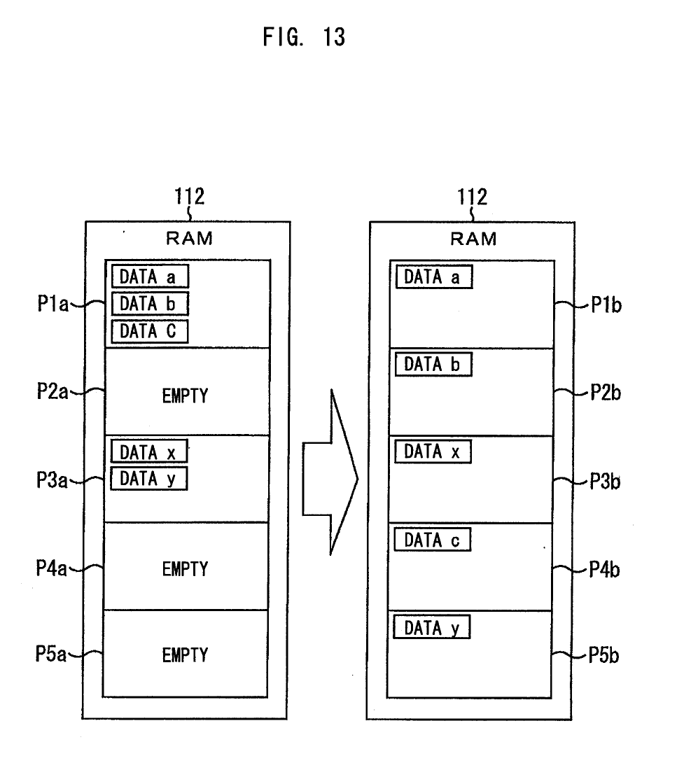

For example, in the case of an example illustrated in FIG. 10, a conversion destination of a virtual address associated with a physical address of the page Pb is changed to a physical address of the prediction page Pa′ on the ROM 113 having a value matching the page Pb. Thereby, thereafter, the CPU 111 reads from the prediction page Pa′ on the ROM 113 in place of the page Pb on the RAM 112 as illustrated in FIG. 11, for example, when the data x is read.

Of course, when the value of the page Pb matches the initial page Pa on the RAM 112, the conversion table is updated so that the initial page Pa is referred to.

In step S44, the memory management section 152 discards the detected page on the RAM 112. For example, in the case of an example illustrated in FIG. 11, the page Pb on the RAM 112 is discarded.

Thereafter, the memory rearrangement process ends.

On the other hand, if the corresponding page, that is, a page on the RAM 112 having a value matching a page on the ROM 113, is determined not to have been detected in step S42, the processes of steps S43 and S44 are skipped and the memory rearrangement process ends.

Thereafter, when data within the prediction page Pa′ is rewritten, the prediction page Pa′ is copied to the RAM 112 and writing is performed for the copied page as when data within the initial page Pa is rewritten.

As described above, if a value of a page on the RAM 112 matches a page on the ROM 113 even after a page is copied from the ROM 113 to the RAM 112, the page on the RAM 112 is discarded and the page on the ROM is referred to. As a result, a use amount of the RAM 112 can be reduced.

Accordingly, the capacity of the RAM 112 can be reduced. Alternatively, more data can be held, or more programs 124 can be simultaneously executed, using the RAM 112 of the same capacity.

In addition, data can be directly read from the ROM 113 without being swapped into the RAM 112. Accordingly, the more data capable of being directly read from the ROM 113, the higher an operation speed can be expected as compared to a swap mechanism of the related art.

### 2. MODIFIED EXAMPLES

Hereinafter, the modified examples of the embodiments of the present technology will be described.

### Modified Example 1

For example, when rewriting a value of a page of the RAM 112 to the same value as in an initial page or a prediction page of the ROM 113, the program 124 may command the memory management section 152 to rearrange the memory. For example, as illustrated in FIG. 10 described above, when the page Pb on the RAM 112 is rewritten to the same value A′ as in the prediction page Pa′ on the ROM 113, the program 124 may command the memory management section 152 to rearrange the page Pb via the memory manager 123.

### Modified Example 2

In addition, for example, a prediction page of a compressed state may be stored in the ROM 113.

For example, a prediction page Pc of FIG. 12 is the compression of the prediction page Pa′ illustrated in FIG. 3 or the like. In this case, for example, when data x within the prediction page Pc is read, the prediction page Pc is decompressed and copied to the RAM 112. The data x is read from a page Pd copied to the RAM 112.

Thereby, a capacity of the ROM 113 can be reduced or more prediction data can be stored in the ROM 113. In addition, a use amount of the RAM 112 can be reduced while data within a corresponding prediction page is read or written after a page on the RAM 112 having a value matching a prediction page on the ROM 113 is discarded by the memory rearrangement process.

In this case, data within the initial page may also be read after a corresponding initial page is shifted from the ROM 113 to the RAM 112. In this case, the ROM 113 does not need to be randomly accessed.

### Modified Example 3

Further, for example, an area may be secured in units of pages when an area of the RAM 112 is secured according to a request from the program 124.

Normally, each program 124 requests the memory manager 123 to secure the area of the RAM 112 in units of data to be actually processed. That is, each program 124 requests the memory manager 123 to secure areas having various sizes in units of addresses.

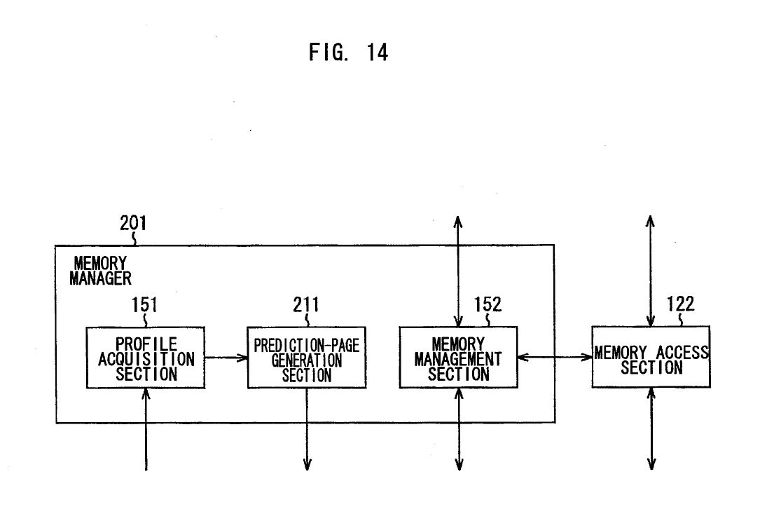

On the other hand, the memory manager 123 of the related art requests the memory management section 152 to secure an area of the RAM 112, for example, by adjusting an arrangement of a plurality of data within one page. As a result, for example, as illustrated on the left of FIG. 13, data a to c are mixed within a page P1a on the RAM 112, and a state in which data x and data y are mixed within a page P3a is reached. Thereby, the use amount of the RAM 112 can be reduced.

However, in this case, for example, if all values of the data a to c in the page P1a do not match a prediction page on the ROM 113, it is not possible to discard the data from the RAM 112. Thus, the page P1a is not likely to be discarded from the RAM 112. This is also the same as in the page P3a.

As illustrated on the right of FIG. 13, an area of the RAM 112 may be secured so that data is stored in each page one by one. That is, the area of the RAM 112 may be secured in units of pages for all data according to a request from each program 124. As a result, pages P1b to P5b are configured to store data a to y one by one.

Thereby, values of the pages P1b to P5b match the prediction page on the ROM 113 and the pages P1b to P5b are likely to be discarded from the RAM 112. As a result, the use amount of the RAM 112 can be reduced.

However, in this case, the use efficiency of a page on the RAM 112 is expected to decrease and the use amount of the RAM 112 is expected to temporarily increase. On the other hand, for example, it is possible to solve this problem by adopting a swap device, memory compression technology, or the like.

For example, a page storing data unused for a long time may be compressed and retained in the RAM 112. In this case, for example, because the number of unused areas is large in the pages P1b to P5b, a compression rate may be high or a reduction effect of the use amount of the RAM 112 may be larger.

In this case, a page of a low compression rate may be preferentially stored in the ROM 113 as a prediction page in addition to a page having a high occurrence frequency or a page having a long occurrence period in the RAM 112. Thereby, the use amount of the RAM 112 can be further reduced.

### Modified Example 4

In addition, for example, a writable storage device such as a flash memory may be used as an auxiliary storage device in place of the ROM 113, a learning process of a prediction page may be performed, and a prediction page may be dynamically generated and stored in the auxiliary storage device.

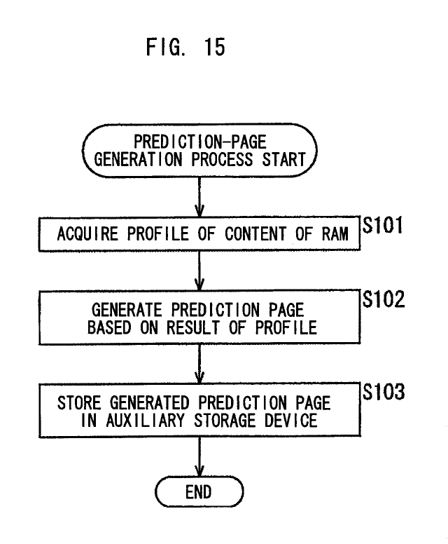

Here, a specific example of the process of this case will be described with reference to FIGS. 14 and 15.

FIG. 14 illustrates a configuration example of a function of a memory manager 201 to be used in place of the memory manager 121 of FIG. 2 when the learning process of the prediction page is performed. The memory manager 201 is configured to include a profile acquisition section 151, a memory management section 152, and a prediction-page generation section 211. In the drawing, parts corresponding to FIG. 2 are denoted by the same reference numerals, and description of parts of the same process is properly omitted.

The profile acquisition section 151 acquires a profile of content of the RAM 112, and supplies the acquired profile to the prediction-page generation section 211.

The prediction-page generation section 211 generates a prediction page on the basis of the profile of the content of the RAM 112, and stores the generated prediction data in the auxiliary storage device.

Next, a prediction-page generation process to be executed by the memory manager 201 during execution of the program 124 will be described with reference to the flowchart of FIG. 15. This process is executed, for example, continuously, periodically every predetermined interval, or when there is a margin in the processing capability of the CPU 111.

In step S101, the profile acquisition section 151 acquires the profile of the content of the RAM 112 during the execution of the program 124, and supplies the acquired profile to the prediction-page generation section 211. At this time, profiles may be continuously acquired or discretely acquired every predetermined interval or when a predetermined condition is satisfied.

In step S102, the prediction-page generation section 211 generates a prediction page on the basis of a profile result. For example, when a page having a value different from that of a prediction page stored in the auxiliary storage device occurs in the auxiliary storage device, the prediction-page generation section 211 generates a page having the same value as the page as a prediction page.

In step S103, the prediction-page generation section 211 stores the generated prediction page in the auxiliary storage device.

Thereafter, the prediction page generation process ends.

Thereby, a value of a page on the RAM 112 is likely to match the prediction page on the auxiliary storage device and the use amount of the RAM 112 can be further reduced.

For example, a prediction page to be stored in the auxiliary storage device may be selected, for example, on the basis of an occurrence frequency or an occurrence time. That is, a page having a high occurrence frequency or a page having a long occurrence time in the RAM 112 may be extracted and stored in the auxiliary storage device.

In addition, for example, a page unused for a long time or a page having a low use frequency among prediction pages stored in the auxiliary storage device may be appropriately deleted.

### Modified Example 5

Further, in an embodiment of the present technology, it is possible to obtain a reduction effect of the use amount of the RAM 112 even when the prediction page is not used. That is, the page is discarded only when a value of a page of the RAM 112 matches an initial page. It is possible to obtain the reduction effect of the use amount of the RAM 112 only when the initial page is referred to.

### Modified Example 6

In addition, a configuration example of software of the information processing system 101 shown above is one example, and other configurations are also possible. For example, all or part of functions of the memory manager 121 and the memory access section 122 may be executed by the memory manager 123 or the program 124. In addition, for example, the memory manager 121 may execute all or part of functions of the memory access section 122. Further, for example, the program 124 may directly request the memory manager 121 and the memory access section 122 to perform a process by omitting the memory manager 123.

### Modified Example 7

Further, although an example in which data of the RAM 112 and the ROM 113 is arranged in units of pages, which are blocks having the same size, has been described above, the present technology is applicable, for example, even when data is arranged in a non-uniform size such as a segment unit or an address unit.

### Modified Example 8

In addition, the above-described series of processes can be executed by software or hardware. For example, the memory access section 122 can be constituted by hardware such as a memory management unit (MMU).

When the series of processes is executed by the software, a program constituting the software is installed in a computer. Here, the computer includes a computer built in dedicated hardware, a general-purpose personal computer, for example, which can execute various functions by installing various programs, or the like.

A program to be executed by the computer can be recorded and provided, for example, on removable media such as package media. In addition, the program can be provided via a wired or wireless transmission medium such as a local area network, the Internet, or digital satellite broadcasting. In addition, the program can be installed in advance on a storage device (for example, the ROM 113) built in a device.

The program to be executed by the computer may be a program of which processes are performed in time series in accordance with the order described in this specification, or a program of which processes are performed in parallel or at necessary timings such as when the processes are called or the like.

In addition, in this specification, the term system means the entire equipment including a plurality of devices, means, and the like.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

A memory management device including

a memory management section for discarding data of a main storage device matching data of an auxiliary storage device during execution of a predetermined program and controlling the discarded data to be read from the auxiliary storage device.

(2)

The memory management device according to (1), wherein the data of the auxiliary storage device includes:

initial data indicating an initial value before the program is executed; and

prediction data predicted to occur in the main storage device during the execution of the program.

(3)

The memory management device according to (2), wherein the prediction data is data predicted on the basis of content of the main storage device when the program is executed.

(4)

The memory management device according to (3), wherein the prediction data is data extracted on the basis of at least one of an occurrence frequency and period from data occurring in the main storage device when the program is executed.

(5)

The memory management device according to any one of (2) to (4), wherein:

the prediction data is stored in the auxiliary storage device in units of blocks having a predetermined size, and

the memory management section secures an area of the main storage device in the units of blocks according to a request from the program.

(6)

The memory management device according to any one of (2) to (5), wherein the prediction data is stored in the auxiliary storage device in a compressed state.

(7)

The memory management device according to any one of (2) to (6), further including:

a prediction-data generation section for generating the prediction data on the basis of the content of the main storage device during the execution of the program and storing the generated prediction data in the auxiliary storage device.

(8)

The memory management device according to any one of (1) to (7), wherein, when data of the auxiliary storage device is rewritten, the memory management section copies the corresponding data to the main storage device and controls the data copied to the main storage device to be rewritten.

(9)

A memory management method including:

discarding data of a main storage device matching data of an auxiliary storage device during execution of a predetermined program; and

controlling the discarded data to be read from the auxiliary storage device.

(10)

A control program for causing a computer to execute a process including:

discarding data of a main storage device matching data of an auxiliary storage device during execution of a predetermined program; and

controlling the discarded data to be read from the auxiliary storage device.

The present disclosure contains subject matter related to that disclosed in Japanese Priority Patent Application JP 2011-087945 filed in the Japan Patent Office on Apr. 12, 2011, the entire content of which is hereby incorporated by reference.

What is claimed is:

1. A memory management device comprising:
a memory management section for discarding data of a main storage device matching data of an auxiliary storage device during execution of a predetermined program and controlling the discarded data to be read from the auxiliary storage device.

2. The memory management device according to claim 1, wherein the data of the auxiliary storage device includes:
initial data indicating an initial value before the program is executed; and
prediction data predicted to occur in the main storage device during the execution of the program.

3. The memory management device according to claim 2, wherein the prediction data is data predicted on the basis of content of the main storage device when the program is executed.

4. The memory management device according to claim 3, wherein the prediction data is data extracted on the basis of at least one of an occurrence frequency and period from data occurring in the main storage device when the program is executed.

5. The memory management device according to claim 2, wherein:
the prediction data is stored in the auxiliary storage device in units of blocks having a predetermined size, and
the memory management section secures an area of the main storage device in the units of blocks according to a request from the program.

6. The memory management device according to claim 2, wherein the prediction data is stored in the auxiliary storage device in a compressed state.

7. The memory management device according to claim 2, further comprising:
a prediction-data generation section for generating the prediction data on the basis of the content of the main storage device during the execution of the program and storing the generated prediction data in the auxiliary storage device.

8. The memory management device according to claim 1, wherein, when data of the auxiliary storage device is rewritten, the memory management section copies the corresponding data to the main storage device and controls the data copied to the main storage device to be rewritten.

9. A memory management method comprising:
discarding data of a main storage device matching data of an auxiliary storage device during execution of a predetermined program; and
controlling the discarded data to be read from the auxiliary storage device.

10. A control program for causing a computer to execute a process comprising:
discarding data of a main storage device matching data of an auxiliary storage device during execution of a predetermined program; and
controlling the discarded data to be read from the auxiliary storage device.
